(19) United States
(12) Patent Application Publication
(10) Pub. No.: US 2010/0207871 A1
(43) Pub. Date: Aug. 19, 2010

(54) METHOD AND PORTABLE APPARATUS

(75) Inventors: Erika Reponen, Tampere (FI); Jarmo Kauko, Tampere (FI); Sami Ronkainen, Oulu (FI); Jonna Hakkila, Kempele (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/596,703

(22) PCT Filed: Jun. 20, 2007
(86) PCT No.: PCT/IB07/01962

§ 371 Date: Apr. 16, 2010

Related U.S. Application Data
(60) Provisional application No. 60/914,124, filed on Apr. 26, 2007.

(51) Int. Cl. G09G 5/00; G06F 3/048

(52) U.S. Cl. 345/156; 715/835

(57) ABSTRACT

A method for a portable apparatus includes detecting a movement of the portable apparatus, and determining that the movement is associated with a user input for retrieving a value of a status of the portable apparatus; determining a value of the status; and presenting the value to the user. Corresponding portable apparatuses and computer program product are also presented.

### CROSS REFERENCE TO RELATED APPLICATIONS

This application is the National Stage of International Application No. PCT/IB2007/001962 International Filing Date, 20 Jun. 2007, which designated the United States of America, and which International Application was published under PCT Article 21 (2) as WO Publication No. 2008/132540 A1 and which claims priority from and the benefit of U.S. Application No. 60/914,124 filed on 26 Apr. 2007, the disclosures of which are incorporated herein by reference in their entireties.

### BACKGROUND

1. Field

The aspects of the disclosed embodiments generally relate to portable apparatuses and more particularly to providing statuses of portable apparatus.

2. Brief Description of Related Developments

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to in- clude not just voice communication, but also various other services and applications such as www/wap browsing, video telephony, electronic messaging (e.g. SMS, MMS, email, instant messaging), digital image or video recording, FM radio, music playback, electronic games, calendar/organizer/time planner, word processing, etc.

Being portable, there are a number of statuses of modern mobile terminals that vary over time. Such statuses can for example be battery level, mobile network signal strength, wireless local area network signal strength, available memory, number of unread messages etc.

One way to solve this is to always present on the display the most important statuses, such as the battery level and mobile network signal strength. However, this is not always available, for example when a screen saver has been activated, not is it particularly exciting or fun for the user.

Consequently, there is a need to provide an improved way of presenting statuses of the mobile terminal to the user.

### SUMMARY

In view of the above, the aspects of the disclosed embodiments are generally directed to solving or at least reduce the problems discussed above.

According to a first aspect of the disclosed embodiments there has been provided a method for a portable apparatus comprising: detecting a movement of the portable apparatus, and determining that the movement is associated with a user input for retrieving a value of a status of the portable apparatus; determining a value of the status; and presenting the value to the user. This allows the user to, simply by moving the portable apparatus according to a user input movement, effect the portable apparatus to present the desired status. There is therefore no need to touch the keypad, allowing the user to get information about the status in situations where key presses may be difficult, such as when the user is wearing gloves, etc.

In the presenting, a plurality of indicators may be presented on a display of the portable apparatus, and the appearance of the plurality of indicators may indicate the value.

The presenting may comprise presentation of moving particles.

Icons may be displayed on the display and the presenting may comprise presentation of a subset of the particles proximate one of the icons and presented with an appearance representing a status of an application related to the icon. This allows for intuitive identification of the application area indicated by the indicators.

In the presenting, the movement of the particles may be affected by the orientation of the portable apparatus. For example, the particles can appear to be affected by gravity this way.

In the presenting, the movement of the particles may be affected by a time elapsed since a last detected movement of the portable apparatus and by an intensity of the last detected movement of the portable apparatus. In other words, effects initiated by movement can for example fade over time. Also, effects could be stronger if the last detected movement is stronger.

In the presenting, the value may be indicated by a characteristic of at least some of the indicators, the characteristic selected from the group consisting of color, size, shape, movement behavior or any combination of these characteristics.

In the presenting, the number of indicators may be associated with the value. In other words, many indicators indicate a high value and fewer indicators indicate a low value, or vice versa.

The indicators may be indicators selected from the group consisting of snowflakes, shining stardust, pearls, jewels, dust, flies, butterflies or any combination of these indicators.

In the detecting a movement, the user input may be associated with a user input for retrieving values of a plurality of statuses of the portable apparatus; in the determining, values may be determined for all of the plurality of statuses; and in the presenting, the values may be presented to the user. In other words, the value of several different statuses may efficiently be presented to the user simultaneously.

In the presenting, vibration pulses may be generated, the vibration pulses indicating the value.

The presenting may comprise generating vibration pulses at specific intervals, the duration of the intervals being indicative of the value.

The presenting may comprise generating vibration pulses with a specific duration, the duration being indicative of the value.

In the presenting, audio effects may be generated, the audio effects indicating the value.

The presenting may comprise generating audio effects at specific intervals, the duration of the intervals being indicative of the value.

The presenting may comprise generating audio effects with a specific duration, the duration being indicative of the value.

In the presenting, the audio effect may differ for different statuses.

In the detecting a movement, other movements of the portable apparatus may be associated with other user inputs, and each of these other user inputs may be used for retrieving other statuses of the portable apparatus.

The status may be a status selected from the group consisting of battery level, available memory, reception level for a mobile communication network, reception level for a wireless local area network, number of unread messages and number of missed calls.

A second aspect of the disclosed embodiments is a portable apparatus comprising: a controller; a motion sensor capable of detecting a movement of the apparatus, wherein the controller is configured to determine if the movement is associated with a user input for retrieving a value of a status of the apparatus; and the controller is further configured to, when it is determined that the movement is associated with the user input, determine a value of the status and present the value to the user, as a response to the user input.

The portable apparatus may be an apparatus selected from the group consisting of a mobile communication terminal, a digital music player a pocket computer and a digital camera.

A third aspect of the disclosed embodiments is a portable apparatus comprising: means for detecting a movement of the portable apparatus, and determining that the movement is associated with a user input for retrieving a value of a status of the portable apparatus; means for determining a value of the status; and means for presenting the value to the user.

A fourth aspect of the disclosed embodiments is a computer program product comprising software instructions that, when executed in a portable apparatus, performs the method according to the first aspect.

A fifth aspect of the disclosed embodiments is a user interface comprising: a movement detector, and an output device, wherein the user interface is arranged to: detect a movement of the portable apparatus, and determine that the movement is associated with a user input for retrieving a value of a status of the portable apparatus; and presenting a value of the status to the user.

Other aspects, features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects of the disclosed embodiments will now be described in more detail, reference being made to the enclosed drawings, in which:

FIG. 1 is a schematic illustration of a cellular telecommunication system, as an example of an environment in which the disclosed embodiments may be applied.

FIG. 2 is a schematic front view illustrating a mobile terminal according to an aspect of the disclosed embodiments.

FIG. 3 is a schematic block diagram representing an internal component, software and protocol structure of the mobile terminal shown in FIG. 2.

FIG. 4 is a flow chart illustrating a method for status check performed in the mobile terminal of FIG. 2.

FIGS. 5a-d are schematic display views illustrating one embodiment of the mobile terminal of FIG. 2.

FIGS. 6a-b are schematic diagrams illustrating how tactile and/or audio feedback can be generated in an embodiment of the mobile terminal of FIG. 2.

FIGS. 7a-b are graphs illustrating how different statuses can be represented in tactile and/or audio signals in the mobile terminal of FIG. 2.

### DETAILED DESCRIPTION OF THE DISCLOSED EMBODIMENTS

The aspects of the disclosed embodiments will now be described more fully hereinafter with reference to the accompanying drawings, in which certain embodiments are shown. The embodiments may, however, be embodied in many different forms and should not be construed as limited to the embodiments set forth herein; rather, these embodiments are provided by way of example so that this disclosure will be thorough and complete, and will fully convey the scope of the disclosed embodiments to those skilled in the art. Like numbers refer to like elements throughout.

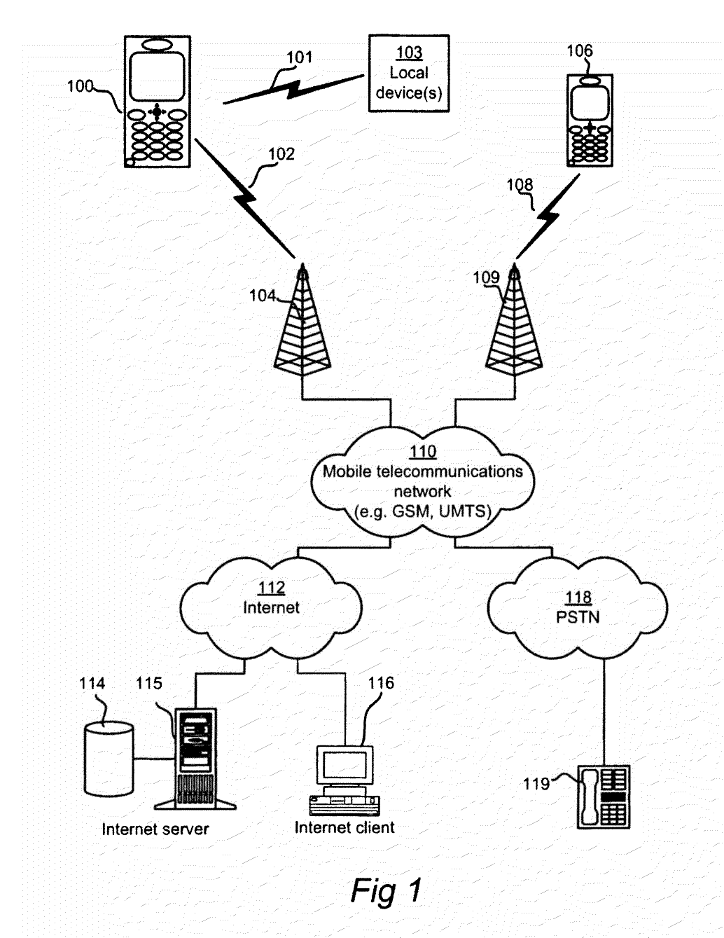

FIG. 1 illustrates an example of a cellular telecommunications system in which the disclosed embodiments may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the disclosed embodiments and other devices, such as another mobile terminal 106 or a stationary telephone 119. It is to be noted that for different embodiments of the mobile terminal 100 and in different situations, different ones of the telecommunications services referred to above may or may not be available; the disclosed embodiments are not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 112, which may be Internet or a part thereof. An Internet server 115 has a data storage 114 and is connected to the wide area network 112, as is an Internet client computer 116. The server 115 may host a www/wap server capable of serving www/wap content to the mobile terminal 100.

A public switched telephone network (PSTN) 118 is connected to the mobile telecommunications network 110 in a familiar manner. Various telephone terminals, including the stationary telephone 119, are connected to the PSTN 118.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc.

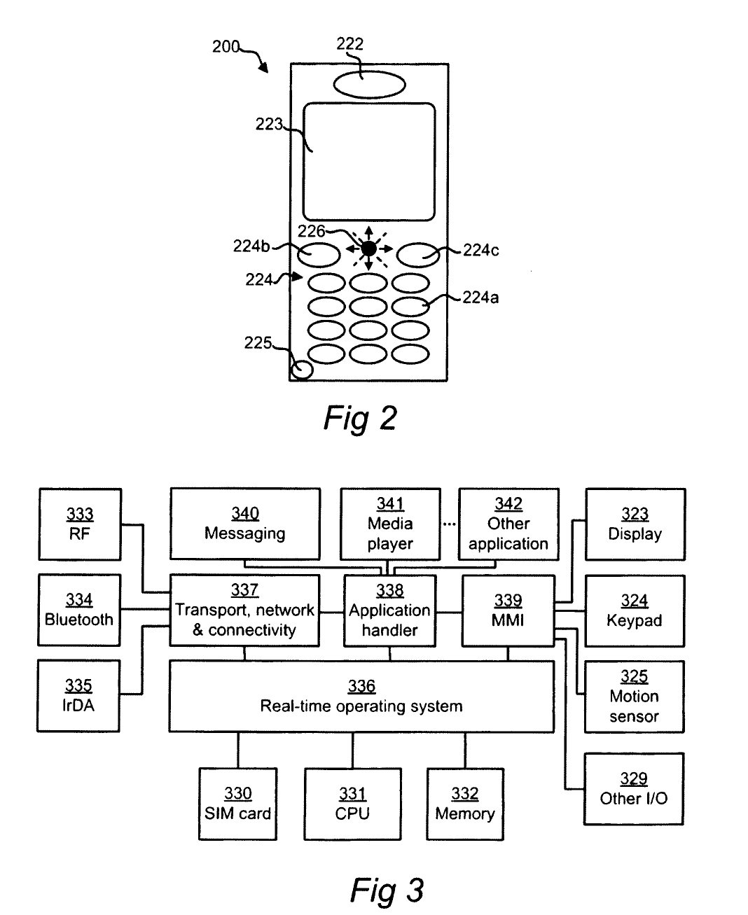

An embodiment 200 of the mobile terminal 100 is illustrated in more detail in FIG. 2. The mobile terminal 200 comprises a speaker or earphone 222, a microphone 225, a display 223 and a set of keys 224 which may include a keypad 224a of common ITU-T type (alpha-numerical keypad representing characters “0”-“9”, “*” and “#”) and certain other keys such as soft keys 224b, 224c and a joystick 226 or other type of navigational input device.

The internal component, software and protocol structure of the mobile terminal 200 will now be described with reference to FIG. 3. The mobile terminal has a controller 331 which is responsible for the overall operation of the mobile terminal and is preferably implemented by any commercially available CPU (“Central Processing Unit”), DSP (“Digital Signal Processor”) or any other electronic programmable logic device. The controller 331 has associated electronic memory 332 such as RAM memory, ROM memory, EEPROM memory, flash memory, or any combination thereof. The memory 332 is used for various purposes by the controller 331, one of them being for storing data and program instructions for various software in the mobile terminal. The software includes a real-time operating system 336, drivers for a man-machine interface (MMI) 339, an application handler 338 as well as various applications. The applications can include a messaging application 340 for sending and receiving SMS, MMS or email, a media player application 341, as well as various other applications 342, such as applications for voice calling, video calling, web browsing, an instant messaging application, a phone book application, a calendar application, a control panel application, a camera application, one or more video games, a notepad application, etc.

The MMI 339 also includes one or more hardware controllers, which together with the MMI drivers cooperate with the display 323/223, keypad 324/224, motion sensor 325, such as an accelerometer, as well as various other I/O devices 329 such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 337 and which provide communication services (such as transport, network and connectivity) for an RF interface 333, and optionally a Bluetooth interface 334 and/or an IrDA interface 335 for local connectivity. The RF interface 333 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 330 and an associated reader. As is commonly known, the SIM card 330 comprises a processor as well as local work and data memory.

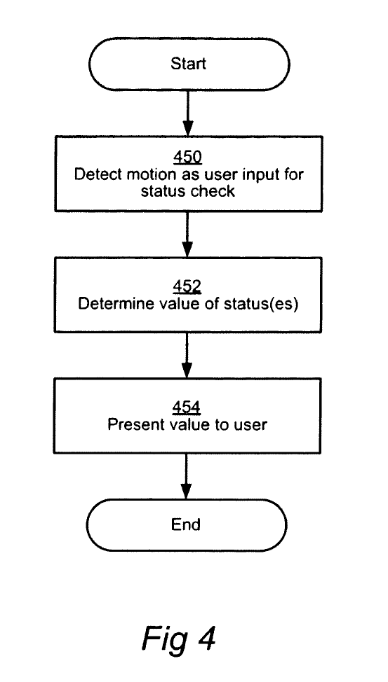

FIG. 4 is a flow chart illustrating a method for status check performed in the mobile terminal of FIG. 2.

In a detect motion as user input to for status check step 450, it is detected that the user has moved the mobile terminal in a particular way. This can for example be a shake of the mobile terminal, a tap on the screen, a double tap on the screen, a circular motion of the apparatus, etc. As a person skilled in the art will realize, there is a large number of ways the mobile terminal can be moved to indicate that a status check is desired. The motion is detected by the motion sensor 325 (FIG. 3). One motion can be used to check several statuses. Optionally, different movements can be used to check different statuses. Typical statuses that can be checked can be battery status, reception strength for mobile network, reception strength for wireless local area network, number of new messages, number or missed calls, etc.

In a determine value of status(es) step 452, the one or several statuses associated with the detected motion are determined. This information is typically available in the mobile terminal and is readily retrieved.

In a present value to user step 454, the status or statuses are presented to the user. As will described in more detail below, this presentation can be visual on the display 223/323, audio, tactile, or any combination of these.

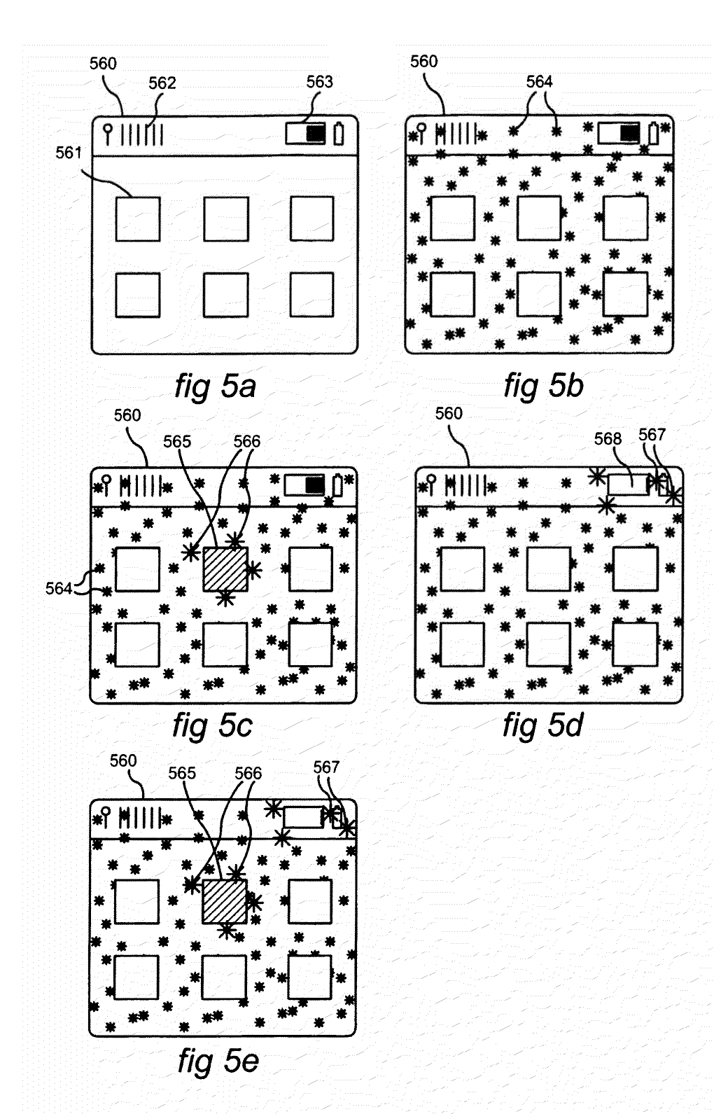

FIGS. 5a-d are schematic display views 560 illustrating one embodiment of the method of FIG. 4. The display views are shown on the display 223/323.

FIG. 5a shows a display view 560 before the status check has been initiated. As is customary, there are a number of icons 561 representing different applications or functions of the mobile terminal. Additionally, there is a separate reception level indicator 562 and a battery level indicator 563.

FIG. 5b shows the display view 560 after the status check has been initiated. A large number of particles 564 are then shown on the display. The particles can be any designed as any visual particle; some examples are: snowflakes, shining stardust, pearls, jewels, dust, flies, and butterflies. The particles may vibrate or change color in their default behavior. Optionally, the particles fall to the bottom of the screen, or if there is a positional detector in the mobile terminal, the particles may fall towards the ground, based on a signal from the positional detector.

FIG. 5c shows the display view 560 when a status of an application is presented. The application represented by the icon 565 here has a status that is presented to the user. For example, the icon 565 may be an icon for the messaging application and there are unread messages in the inbox. This status is indicated by particles 566 in the proximity of the messaging icon 565 being larger than the other particles 564. Optionally, if particles move around the screen, the particles grow bigger as they approach the messaging icon. The particles can change any other characteristic to indicate a status of an icon or other user interface element. For example, the particles can change color, shape, movement speed, movement behavior, etc. As an example of movement behavior, the particles could fall into orbit around an icon when they are in proximity to indicate a particular status.

FIG. 5d shows the display view 560 when a general status of the mobile terminal is presented. In this example, the battery level is low, which can be seen on the battery indicator 568. Additionally, particles 567 in the proximity of the battery indicator grow larger.

It is to be noted that several statuses could be indicated at any one time. FIG. 5e shows the display view 560 when a low battery level is indicated with particles 567. Additionally, particles 566 in the proximity of the messaging icon 565 indicate that there are unread messages in the inbox. In one embodiment the particles 567 indicating low battery have one color, e.g. red, and the particles 566 indicating a new message have another color, e.g. green.

The particles illustrated above could be generated through particle functionality of a graphics interface, e.g. a 3D graphics interface of the mobile terminal.

In one embodiment, some of the user interface elements affect the behavior of the particles, even if the state related to the user interface element is a normal state.

In one embodiment, the particles are snow flakes and are affected by gravity (virtual or real) as discussed above, and the particles are activated by shaking the mobile terminal. The combined effect of this is similar to a snow globe, where little snow flakes inside are agitated when shaken and slowly fall to the bottom of the snow globe.

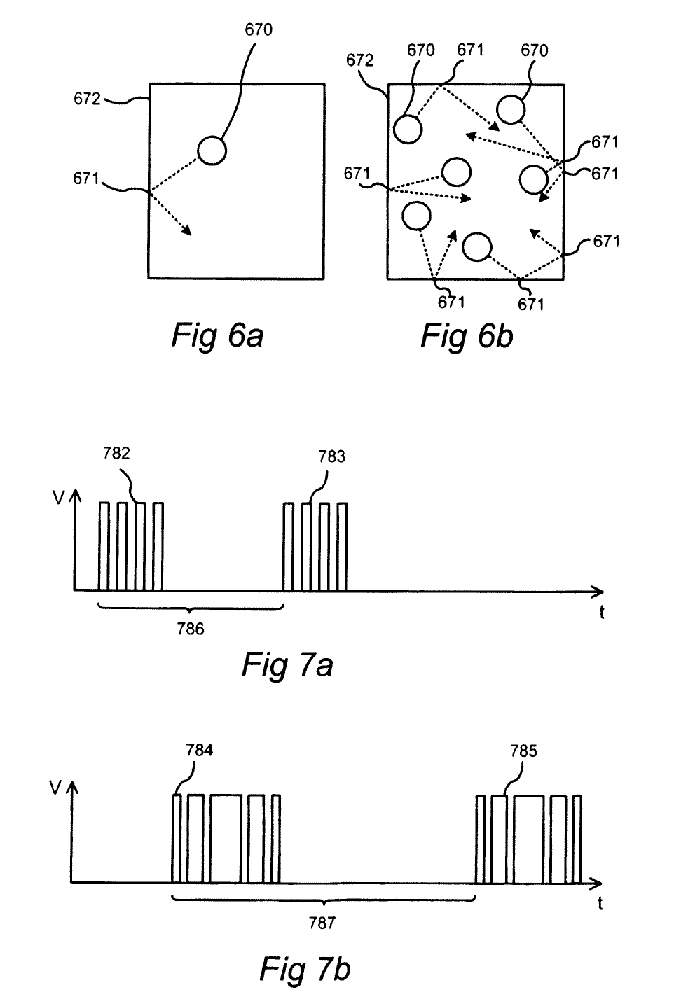

FIGS. 6a-b are schematic diagrams illustrating how tactile and/or audio feedback can be generated in an embodiment of the method of FIG. 4.

In FIG. 6a, a ball 670 is shown within a confined space 672. This has a certain velocity and direction and will bounce 671 on the wall and continue until it bounces again etc. It is possible to generate a sound effect and/or a vibration corresponding to the times when the ball 670 bounces on the wall, optionally without showing this situation graphically on a display.

In FIG. 6b, a relatively large number of balls 670 are present within the confined space 672, generating more bounces 671 per unit of time. Again, these bounces 671 can be represented with sound and/or vibration effects. The user will thus get a sensation that something is more full, compared to the situation in FIG. 6a.

The situation illustrated by FIGS. 6a-b can thus be used to convey information to the user about the status of one or more applications. Optionally, several statuses can be multiplexed using different vibration patterns and/or sound effects for the different statuses, as is explained below.

FIGS. 7a-b are graphs illustrating how different statuses can be represented in tactile and/or audio signals. The horizontal axis represents time and the vertical axis represents vibration and/or audio signal level.

In FIG. 7a, a first status is represented by pulses 782 and 783. The interval 786 between the pulses 782 and 783 is an indicator of the first status. Note the profile of the pulses 782 and 783, where each pulse consists of four equidistant vibrations/sounds of equal length.

In FIG. 7b, a second status is represented by pulses 784 and 785, where the interval 787 between the pulses 784 and 785 indicate the value of the second status. Here the profile of the pulses 784 and 785 are different from the pulses 782 and 783 for the first status. As can be seen in the graph, the vibrations/sounds first increase and then decrease in length.

Consequently, the pulses 782 and 783 for the first status and the pulses 784 and 785 for the second status can be multiplexed, whereby the user still can sense the values of the individual statuses. If the pulses are kept sufficiently short and distinct, three or more statuses can be multiplexed. As can be readily understood by a person skilled in the art, many other pulse profiles than those shown here can be used without departing from the scope of the appended claims.

The tactile feedback can be created with vibration motor. Alternatively, a piezoelectric actuator can be used, whereby more control over different sensations is achieved, resulting in possibly even more different statuses which could be presented simultaneously.

Although the disclosed embodiments have been described using an embodiment in a mobile terminal, the disclosed embodiments are applicable to any type portable apparatus, including portable mp3-players, cameras, pocket computers etc.

The disclosed embodiments have mainly been described above with reference to a few embodiments. However, as is readily appreciated by a person skilled in the art, other embodiments than the ones disclosed above are equally possible within the scope of the disclosed embodiments, as defined by the appended patent claims.

What is claimed is:

1. A method for a portable apparatus comprising:
detecting a movement of said portable apparatus, and determining that said movement is associated with a user input for retrieving a value of a status of said portable apparatus;
determining a value of said status; and
presenting said value to said user.

2. The method according to claim 1, wherein in said presenting, a plurality of indicators are presented on a display of said portable apparatus, and the appearance of said plurality of indicators indicates said value.

3. The method according to claim 2, wherein said presenting comprises presentation of moving particles.

4. The method according to claim 3, wherein icons are displayed on said display and said presenting comprises presentation of a subset of said particles proximate one of said icons and presented with an appearance representing a status of an application related to said icon.

5. The method according to claim 3, wherein in said presenting, the movement of said particles are affected by the orientation of said portable apparatus.

6. The method according to claim 3, wherein in said presenting, the movement of said particles are affected by a time elapsed since a last detected movement of said portable apparatus and by an intensity of said last detected movement of said portable apparatus.

7. The method according to claim 2, wherein in said presenting, said value is indicated by a characteristic of at least some of said indicators, said characteristic selected from the group consisting of color, size, shape, movement behavior or any combination of these characteristics.

8. The method according to claim 2, wherein in said presenting, the number of indicators are associated with said value.

9. The method according to claim 2, wherein said indicators are indicators selected from the group consisting of snowflakes, shining stardust, pearls, jewels, dust, flies, butterflies or any combination of these indicators.

10. The method according to claim 1, wherein
in said detecting a movement, said user input is associated with a user input for retrieving values of a plurality of statuses of said portable apparatus;
in said determining, values are determined for all of said plurality of statuses; and
in said presenting, said values are presented to said user.

11. The method according to claim 10, wherein in said presenting, vibration pulses are generated, said vibration pulses indicating said value.

12. The method according to claim 11, wherein said presenting comprises generating vibration pulses at specific intervals, the duration of said intervals being indicative of said value.

13. The method according to claim 11, wherein said presenting comprises generating vibration pulses with a specific duration, said duration being indicative of said value.

14. The method according to claim 10, wherein in said presenting, audio effects are generated, said audio effects indicating said value.

15. The method according to claim 14, wherein said presenting comprises generating audio effects at specific intervals, the duration of said intervals being indicative of said value.

16. The method according to claim 14, wherein said presenting comprises generating audio effects with a specific duration, said duration being indicative of said value.

17. The method according to claim 14, wherein in said presenting, said audio effect differs for different statuses.

18. The method according to claim 10, wherein in said detecting a movement, other movements of said portable apparatus are associated with other user inputs, and each of these other user inputs are used for retrieving other statuses of said portable apparatus.

19. The method according to claim 10, wherein said status is a status selected from the group consisting of battery level, available memory, reception level for a mobile communication network, reception level for a wireless local area network, number of unread messages and number of missed calls.

20. A portable apparatus comprising:
a controller;
a motion sensor capable of detecting a movement of said apparatus,
wherein said controller is configured to determine if said movement is associated with a user input for retrieving a value of a status of said apparatus; and
said controller is further configured to, when it is determined that said movement is associated with said user input, determine a value of said status and present said value to said user, as a response to said user input.

21. The portable apparatus according to claim 20, wherein
said controller is further configured to present a plurality of indicators on a display of said portable apparatus, and the appearance of said plurality of indicators indicates said value.

22. The portable apparatus according to claim 20, wherein:
said user input is associated with a user input for retrieving values of a plurality of statuses of said portable apparatus;
said controller is configured to determine values for all of said plurality of statuses and present said values said user.

23. The portable apparatus according to claim 20, wherein said portable apparatus is an apparatus selected from the group consisting of a mobile communication terminal, a digital music player a pocket computer and a digital camera.

24. A portable apparatus comprising:
means for detecting a movement of said portable apparatus, and determining that said movement is associated with a user input for retrieving a value of a status of said portable apparatus;
means for determining a value of said status; and
means for presenting said value to said user.

25. A computer program product comprising software instructions that, when executed in a portable apparatus, performs the method according to claim 1.

26. A user interface comprising:
a movement detector, and
an output device,
wherein said user interface is arranged to:
detect a movement of said portable apparatus, and determine that said movement is associated with a user input for retrieving a value of a status of said portable apparatus; and
presenting a value of said status to said user.
